(19) United States
(12) Patent Application Publication
(10) Pub. No.: US 2012/0157634 A1
(43) Pub. Date: Jun. 21, 2012

(54) Soft Particulate Superabsorbent and Use Thereof

(75) Inventor: Francisco Javier Lopez Villanueva, Mannheim (DE)

(73) Assignee: BASF SE, Ludwigshafen (DE)

(21) Appl. No.: 13/391,724

(22) PCT Filed: Aug. 11, 2010
(86) PCT No.: PCT/EP2010/061658

§ 371 Date: Feb. 22, 2012

(30) Foreign Application Priority Data
Aug. 25, 2009 (EP) 09168584.2

(51) Int. Cl. C08F 8/44; B29C 47/36; C08F 122/02; C08F 128/02; C08F 120/06; C08F 122/06

(52) U.S. Cl. 525/327.6; 526/317.1; 526/271; 526/318.2; 526/287; 525/328.5; 525/329.9; 525/329.5; 264/211

(57) ABSTRACT

Particulate superabsorbents based on at least one monoethylenically unsaturated monomer comprising at least one acid group, in which at least 5 mol % of the acid groups have been neutralized with at least one tertiary alkanolamine, are particularly suitable superabsorbent components of thermoplastic mixtures which are shaped by known shaping processes for thermoplastics to give shaped bodies comprising superabsorbents.

The present invention relates to soft particulate superabsorbents, to the use thereof and to products comprising such superabsorbents and thermoplastic polymers. More particularly, it also relates to the processing of polymer mixtures comprising superabsorbents by shaping processes for thermoplastics, for example extrusion.

Superabsorbents are known. For such materials, names such as “high-swellability polymer”, “hydrogel” (often also used for the dry form), “hydrogel forming polymer”, “water-absorbing polymer”, “absorbent gel-forming material”, “swellable resin”, “water-absorbing resin”, “water-absorbing polymer” or the like are also in common use. The substances in question are crosslinked hydrophilic polymers, especially polymers of (co)polymerized hydrophilic monomers, graft (co)polymers of one or more hydrophilic monomers on a suitable graft base, crosslinked cellulose ethers or starch ethers, crosslinked carboxymethylcellulose, partly crosslinked polyalkylene oxide or natural products which are swellable in aqueous liquids, for example guar derivatives, of which superabsorbents based on partly neutralized acrylic acid are the most widespread. The essential properties of superabsorbents are their abilities to absorb several times their own weight of aqueous liquids and not to release the liquid again even under a certain pressure. The superabsorbent, which is used in the form of a dry powder, is converted to a gel when it absorbs liquid, and correspondingly to a hydrogel when it absorbs water as usual. Crosslinking is essential for synthetic superabsorbents and is an important difference from customary pure thickeners, since it leads to the insolubility of the polymers in water. Soluble substances would not be usable as superabsorbents. By far the most important field of use of superabsorbents is the absorption of body fluids. Superabsorbents are used, for example, in diapers for infants, incontinence products for adults or feminine hygiene products. Other fields of use are, for example, as water-retaining agents in market gardening, as water stores for protection from fire, for liquid absorption in food packaging, or quite generally for absorbing moisture.

Superabsorbents can absorb several times their own weight of water and retain it under a certain pressure. In general, such a superabsorbent has a CRC (“centrifuge retention capacity”, see below for test method) of at least 5 g/g, preferably at least 10 g/g and more preferably at least 15 g/g. A “superabsorbent” may also be a mixture of different individual superabsorbent substances or a mixture of components which exhibit superabsorbent properties only when they interact; it is not so much the substance composition as the superabsorbent properties that are important here.

What is important for a superabsorbent is not just its absorption capacity but also the ability to retain liquid under pressure (retention, usually expressed as “absorption under load” (“AUL”) or “absorption against pressure” (“AAP”)) and liquid transport in the swollen state (usually expressed as “saline flow conductivity” (“SFC”)). Swollen gel can hinder or prevent liquid transport to as yet unswollen superabsorbent (“gel blocking”). Good transport properties for liquids are possessed, for example, by hydrogels which have a high gel strength in the swollen state. Gels with only a low gel strength are deformable under an applied pressure (body pressure), block pores and thus prevent further absorption of liquid. An increased gel strength is generally achieved through a higher degree of crosslinking, which, however, reduces the absorption capacity of the product. An elegant method of increasing the gel strength is that of increasing the degree of crosslinking at the surface of the superabsorbent particles compared to the interior of the particles. To this end, superabsorbent particles which have usually been dried in a surface postcrosslinking step and have an average crosslinking density are subjected to additional crosslinking in a thin surface layer of the particles thereof. The surface postcrosslinking increases the crosslinking density in the shell of the superabsorbent particles, which raises the absorption under compressive stress to a higher level. While the absorption capacity in the surface layer of the superabsorbent particles falls, their core, as a result of the presence of mobile polymer chains, has an improved absorption capacity compared to the shell, such that the shell structure ensures improved liquid conduction, without occurrence of gel blocking. It is likewise known that superabsorbents which are relatively highly crosslinked overall can be obtained and the degree of crosslinking in the interior of the particles can subsequently be reduced compared to an outer shell of the particles.

Processes for producing superabsorbents are also known. Superabsorbents based on acrylic acid, which are the most common on the market, are produced by free-radical polymerization of acrylic acid in the presence of a crosslinker (the “inner crosslinker”), the acrylic acid being neutralized to a certain degree before, after or partly before and partly after the polymerization, typically by adding alkali, usually an aqueous sodium hydroxide solution. The polymer gel thus obtained is comminuted (according to the polymerization reactor used, this can be done simultaneously with the polymerization) and dried. The dry powder thus obtained (the “base polymer”) is typically postcrosslinked on the surface of the particles, by reacting it with further crosslinkers, for instance organic crosslinkers or polyvalent cations, for example aluminum (usually used in the form of aluminum sulfate) or both, in order to obtain a more highly crosslinked surface layer compared to the particle interior.

Fredric L. Buchholz and Andrew T. Graham (eds.), in: “Modern Superabsorbent Polymer Technology”, J. Wiley & Sons, New York, U.S.A./Wiley-VCH, Weinheim, Germany, 1997, ISBN 0-471-19411-5, give a comprehensive overview of superabsorbents, properties thereof and processes for producing superabsorbents.

U.S. Pat. No. 5,352,480 teaches methods of binding superabsorbents to fibers, with substances including amino alcohols. WO 03/104 543 A1 teaches that triethanolamine is preferably used for binding of superabsorbents to fibers, the triethanolamine simultaneously serving to increase the degree of neutralization of the superabsorbents.

WO 2009/060 062 A1 mentions the possible use of triethanolamine as a surface postcrosslinker for superabsorbents.

EP 725 084 A1 mentions triethanolamine as a possible polymerization regulator in the (optionally crosslinking) polymerization of ethylenically unsaturated monomers.

WO 99/44 648 A1 teaches the production of flexible superabsorbent foams, in which a monomer mixture which comprises acrylic acid and triethanolamine as neutralizing agents is foamed and polymerized. According to the teaching of WO 00/52087 A1, this foaming is effected by injecting an inert gas into the monomer mixture and then decompressing.

WO 03/092 757 A1 discloses two possible uses of triethanolamine in superabsorbents. According to the teaching of this document, triethanolamine is a plasticizer for a special case of superabsorbents, specifically that of a mixture of a lightly crosslinked acidic polymer with a lightly crosslinked basic polymer, which, according to this document, is used in the form of a flexible layer. This document additionally teaches that the flexible layer may comprise up to 20% by weight of a conventional superabsorbent partly neutralized with common alkalis such as sodium hydroxide, potassium hydroxide or triethanolamine, the use of triethanolamine giving rise to a plastified conventional superabsorbent which does not adversely affect the flexibility of the absorber layer and can even contribute thereto.

It is also known to use superabsorbents as a constituent of polymer mixtures which have water-absorbing properties. These polymer mixtures are often thermoplastic and are shaped with customary shaping methods for thermoplastics, for example to polymer films or other shaped bodies comprising superabsorbents. The superabsorbent imparts water-absorbing properties to these films, which may serve various purposes.

DE 101 43 002 A1 discloses a film-like flat structure provided with channels, in which superabsorbent particles are embedded into a matrix composed of water-resistant polymer. This structure is obtained, for example, by adding superabsorbent particles in the course of extrusion of the water-resistant polymer. EP 1 616 906 A1 teaches water-swellable compositions which comprise elastomeric material and superabsorbent dispersed in a thermoplastic matrix. Such moldings can be obtained by conventional methods of thermoplastic processing, such as extrusion, injection molding, blow molding, thermoforming, calendering or compression molding. WO 03/022 316 indicates that particular particle size distributions of superabsorbents may be advantageous for individual end uses, for instance coextrusion with thermoplastics.

The superabsorbent itself is not a thermoplastic. Superabsorbent particles in the dry state are comparatively hard or brittle. In the case of shaping of thermoplastic mixtures comprising superabsorbents, the problem may therefore occur that the brittle or in any case hard superabsorbent particles in the material which is plastified as a result of heating during the shaping disrupt the processing of this material. One problem may, for example, be the abrasion of shaping tools. By its nature, this occurs particularly where the thermoplastic material is moved under pressure past a tool or through a tool. Particularly prone are nozzles of all kinds, through which the thermoplastic material is pressed, for instance nozzles or mouthpieces of extruders. The simplest known measure for reducing the brittleness or hardness of superabsorbents, specifically the establishment of a minimum water content, often does not lead to the goal in shaping processes for thermoplastics, since the material to be shaped in the shaping processes is heated, which leads to evaporation of the water. Problems with increasingly brittle superabsorbent particles may then be compounded by problems with vapor bubbles in the thermoplastic material.

It is therefore an object of the present invention to find novel or improved superabsorbents and processes for producing such superabsorbents, which are suitable especially for further processing as a constituent of thermoplastic materials with customary shaping methods for thermoplastics.

Accordingly, a particulate superabsorbent based on at least one monoethylenically unsaturated monomer comprising at least one acid group has been found, wherein at least 5 mol % of the acid groups have been neutralized with at least one tertiary alkanolamine. This superabsorbent is notable in that it leads to fewer problems in the course of processing as a constituent of thermoplastic materials and more particularly to less abrasion of shaping tools. Additionally found have been a process for producing this superabsorbent, uses of this superabsorbent and shaped bodies which comprise this superabsorbent, and processes for production thereof.

The superabsorbents present in the inventive mixture can be produced in different ways, for example by solution polymerization, suspension polymerization, dropletization or spray polymerization. Such processes are known. To produce common superabsorbents, typically at least one monoethylenically unsaturated monomer comprising at least one acid group is polymerized in the presence of a crosslinker.

An example of a currently commercially customary polymerization process for preparing acrylate superabsorbents is the aqueous solution polymerization of a monomer mixture comprising
a) at least one ethylenically unsaturated monomer which bears acid groups and is optionally present at least partly in salt form,
b) at least one crosslinker,
c) at least one initiator,
d) optionally one or more ethylenically unsaturated monomers copolymerizable with the monomers specified under a), and
e) optionally one or more water-soluble polymers.

The monomers a) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids or salts thereof, such as acrylic acid, methacrylic acid, maleic acid, maleic anhydride and itaconic acid or salts thereof. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomer solution comprises preferably at most 250 ppm by weight, preferably at most 130 ppm by weight, more preferably at most 70 ppm by weight and preferably at least 10 ppm by weight, more preferably at least 30 ppm by weight, especially around 50 ppm by weight, of hydroquinone monoether, based in each case on the unneutralized monomer a); neutralized monomer a), i.e. a salt of the monomer a), is considered for arithmetic purposes as unneutralized monomer. For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) (“inner crosslinkers”) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 530 438 A1, di- and triacrylates, as described in EP 547 847 A1, EP 559 476 A1, EP 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/32962 A2.

Preferred crosslinkers b) are pentaerythrityl triallyl ether, tetraallyloxyethane, methylenebismethacrylamide, 10 to 20-tuply ethoxylated trimethylolpropane triacrylate, 10 to 20-tuply ethoxylated trimethylolethane triacrylate, more preferably 15-tuply ethoxylated trimethylolpropane triacrylate, polyethylene glycol diacrylates with from 4 to 30 ethylene oxide units in the polyethylene glycol chain, trimethylolpropane triacrylate, di- and triacrylates of 3 to 30-tuply ethoxylated glycerol, more preferably di- and triacrylates of 10-20-tuply ethoxylated glycerol, and triallylamine. The polyols incompletely esterified with acrylic acid may also be present here in the form of Michael adducts with themselves, as a result of which tetraacrylates, pentaacrylates or even higher acrylates may also be present.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably from 0.05 to 1.5% by weight, more preferably from 0.1 to 1% by weight, most preferably from 0.3 to 0.6% by weight, based in each case on monomer a). With rising crosslinker content, the centrifuge retention capacity (CRC) falls and the absorption under a pressure of 0.3 psi (AUL 0.3 psi) rises.

The initiators c) may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite (as Brüggolit® FF6M or Brüggolit® FF7, alternatively BRUGGOLITE® FF6M or BRUGGOLITE® FF7 obtainable from L. Brüggemann KG, Salzstrasse 131, 74076 Heilbronn, Germany, www.brueggemann.com).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate, maleic acid and maleic anhydride.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight, most preferably from 50 to 65% by weight. It is also possible to use monomer suspensions, i.e. oversaturated monomer solutions. With rising water content, the energy expenditure in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

The monomer mixture may comprise further components. Examples of further components used in monomer mixtures of this kind are, for instance, chelating agents, in order to keep metal ions in solution.

Suitable polymerization reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/38402 A1. Polymerization on a belt is described, for example, in DE 38 25 366 A1 and U.S. Pat. No. 6,241,928. Polymerization in a belt reactor forms a polymer gel, which has to be comminuted in a further process step, for example in a meat grinder, extruder or kneader. However, it is also possible to produce spherical superabsorbent particles by suspension, spray or dropletization polymerization processes.

The acid groups of the resulting polymer gels have typically been partially neutralized. Neutralization is preferably carried out at the monomer stage; in other words, salts of the monomers bearing acid groups or, to be precise, a mixture of monomers bearing acid groups and salts of the monomers bearing acid groups (“partly neutralized acid”) are used as component a) in the polymerization. This is typically done by mixing the neutralizing agent as an aqueous solution or preferably also as a solid into the monomer mixture intended for polymerization or preferably into the monomer bearing acid groups or a solution thereof. The degree of neutralization is generally at least 5 mol %, preferably at least 10 mol % and more preferably at least 20 mol %, for instance at least 40 mol % or for instance at least 50 mol %, and generally at most 95 mol %, preferably at most 85 mol % and more preferably at most 80 mol %.

The customary neutralizing agents can be used. These are preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metal cations are sodium and potassium, but very particular preference is given to sodium hydroxide, sodium carbonate or sodium hydrogencarbonate and primary, secondary and tertiary alkanolamines, and mixtures of these neutralizing agents.

However, the inventive superabsorbent additionally or exclusively comprises at least one tertiary alkanolamine in each case as a neutralizing agent. In general, at least 5 mol % of the acid groups in the superabsorbent have been neutralized by tertiary alkanolamine, preferably at least 10% and more preferably at least 20 mol %. In addition to tertiary alkanolamine, the superabsorbent may comprise further neutralizing agent in order to establish the degree of neutralization desired overall (i.e. the proportion of neutralized acid groups (in mol %) among all acid groups). For example, the superabsorbent may be neutralized partly with alkanolamine and partly with alkali, for instance sodium or potassium. The overall degree of neutralization in the inventive superabsorbent is generally at least 20 mol%, preferably at least 50 mol % and more preferably at least 60 mol %, and generally at most 95 mol %, preferably at most 85 mol % and more preferably at most 80 mol%. However, it is preferred that the superabsorbent comprises essentially no other neutralizing agent apart from tertiary alkanolamine, i.e., with the exception of unavoidable impurities or insignificant amounts of other neutralizing agents, is neutralized with tertiary alkanolamine. More particularly, it is preferred that the superabsorbent comprises no other neutralizing agent apart from tertiary alkanolamine, with the exception of unavoidable impurities.

It is also possible to perform the neutralization after the polymerization, at the stage of the polymer gel formed in the polymerization. In addition, it is possible to neutralize some of the acid groups before the polymerization, by adding a portion of the neutralizing agent actually to the monomer solution and establishing the desired final degree of polymerization only after the polymerization, at the polymer gel stage. For example, it is possible to partly neutralize with tertiary alkanolamine at the monomer stage and to establish the desired final degree of neutralization with primary or secondary alkanolamine or alkalis such as sodium hydroxide after the polymerization, or this addition sequence can be reversed. When the polymer gel is at least partly neutralized after the polymerization, the polymer gel is preferably comminuted mechanically, for example by means of an extruder, in which case the neutralizing agent is sprayed on, scattered over or poured on and then mixed in carefully. To this end, the gel material obtained can be repeatedly extruded for homogenization.

This postneutralization preferably precedes the drying.

However, preference is given to performing the neutralization at the monomer stage. In other words: in a very particularly preferred embodiment, the monomer a) used is a mixture of as many mol % of salt of the monomer bearing acid groups as corresponds to the desired degree of neutralization and the remainder to 100 mol % of monomer bearing acid groups. This mixture is, for example, a mixture of triethanolammonium acrylate and acrylic acid.

The alkanolamines can be used in the neutralization at the monomer stage or in the postneutralization of the polymer in pure form or as solution in solvents or solvent mixtures. The solvents used for alkanolamines may, for example, be water, methanol, ethanol, isopropanol or acetone, preference being given to water or use without solvent.

The tertiary alkanolamines used may be monofunctional or polyfunctional bases. The alkanolamines may, in addition to their amino and hydroxyl groups, bear further functional groups, for example ester, urethane, ether, thioether, urea, etc. It is possible to use, for example, low molecular weight compounds such as triethanolamine, methyldiethanolamine, dimethylethanolamine, N-hydroxyethylmorpholine, dimethylaminodiglycol, N,N,N′,N′-tetra(hydroxyethyl)ethylenediamine, N, N, N′, N′-tetra(hydroxypropyl)ethylenediamine, dimethylaminotriglycol, diethylaminoethanol, 3-dimethylamino-1,2-propanediol, triisopropanolamine, diisopropylaminoethanol, choline hydroxide, choline carbonate or else oligomers or polymers, for example polymers or condensates which bear amino groups and have been reacted with ethylene oxide, propylene oxide, glycidol or other epoxides, reaction products formed from at least bifunctional, low molecular weight alkanolamines with at least bifunctional reagents which are capable of reacting either with the hydroxyl group or the amino group of the alkanolamines, for instance carboxylic acids, esters, epoxides or isocyanates.

Tertiary alkanolamines used with preference are triethanolamine, methyldiethanolamine, dimethylaminodiglycol, dimethylethanolamine and N,N,N′,N′-tetra(hydroxyethyl)ethylenediamine. Triethanolamine is very particularly preferred.

In a preferred embodiment, the neutralizing agents used for the neutralization are those whose iron content is generally below 10 ppm by weight, preferably below 2 ppm by weight and more preferably below 1 ppm by weight. Likewise desired is a low content of chloride and anions of oxygen acids of chlorine.

The polymer gel obtained from the aqueous solution polymerization and, if appropriate, subsequent neutralization is then preferably dried with a belt drier until the residual moisture content is preferably from 0.5 to 15% by weight, more preferably from 1 to 10% by weight, most preferably from 2 to 8% by weight (see below for test method for the residual moisture or water content). In the case of too high a residual moisture content, the dried polymer gel has too low a glass transition temperature Tg and can be processed further only with difficulty. In the case of too low a residual moisture content, the dried polymer gel is too brittle and, in the subsequent comminution steps, undesirably large amounts of polymer particles with too low a particle size (“fines”) are obtained. The solids content of the gel before drying is generally from 25 to 90% by weight, preferably from 30 to 80% by weight, more preferably from 35 to 70% by weight, most preferably from 40 to 60% by weight. Optionally, however, it is also possible to dry using a fluidized bed drier or a heatable mixer with a mechanical mixing unit, for example a paddle drier or a similar drier with mixing tools of different design. Optionally, the drier can be operated under nitrogen or another nonoxidizing inert gas or at least under reduced partial oxygen pressure in order to prevent oxidative yellowing processes. In general, however, even sufficient venting and removal of water vapor leads to an acceptable product. A very short drying time is generally advantageous with regard to color and product quality. In the case of the common belt driers, in a customary operating mode, a temperature of the gas used for drying of at least 50° C., preferably at least 80° C. and more preferably of at least 100° C., and generally of at most 250° C., preferably at most 200° C. and more preferably of at most 180° C., is established for this purpose. Suitable belt driers often have several chambers; the temperature in these chambers may be different. In each drier type, the operating conditions should be selected overall in a known manner such that the drying outcome desired is achieved.

During the drying, the residual monomer content in the polymer particles is also reduced, and last residues of the initiator are destroyed.

Thereafter, the dried polymer gel is ground and classified, apparatus usable for the grinding typically including single- or multistage roll mills, preferably two- or three-stage roll mills, pin mills, hammer mills or vibratory mills. Oversize gel lumps which often still have not dried on the inside are elastomeric, lead to problems in the grinding and are preferably removed before the grinding, which can be done in a simple manner by wind sifting or by means of a screen (“protective screen” for the mill). In view of the mill used, the mesh size of the screen should be selected such that a minimum level of disruption resulting from oversize, elastomeric particles occurs. No later than as a result of grinding, the dried polymer gel (which, according to the polymerization apparatus used and any comminution apparatus used downstream of the reactor, may already be crumbly) gives a particulate superabsorbent, i.e. a superabsorbent in the form of individual particles.

The superabsorbent is typically classified subsequently, in order to obtain a product of the desired particle size distribution. This is done by customary classification processes, for example wind sifting, or by screening through screens with suitable mesh sizes. Typical screen cuts for hygiene applications of superabsorbents are at most 1000 μm, preferably at most 900 μm, more preferably at most 850 μm and most preferably at most 800 μm. For example, screens of mesh size 700 μm, 650 μm or 600 μm are used. The coarse polymer particles (“oversize”) removed may, for cost optimization, be sent back to the grinding and screening cycle or be processed further separately.

Polymer particles with too low a particle size lower the permeability (SFC). Advantageously, fine polymer particles are therefore also removed in this classification.

This can, if screening is effected, conveniently be used through a screen of mesh size of at most 300 μm, preferably at most 200 μm, more preferably at most 150 μm and most preferably at most 100 μm. The fine polymer particles (“undersize” or “fines”) removed can, for cost optimization, be sent back as desired to the monomer stream, to the polymerizing gel or to the fully polymerized gel before the drying of the gel.

The mean particle size of the polymer particles removed as the product fraction for hygiene applications is generally at least 200 μm, preferably at least 250 μm and more preferably at least 300 μm, and generally at most 600 μm and more preferably at most 500 μm. The proportion of particles with a particle size of at least 150 μm is generally at least 90% by weight, more preferably at least 95% by weight and most preferably at least 98% by weight. The proportion of particles with a particle size of at most 850 μm is generally at least 90% by weight, more preferably at least 95% by weight and most preferably at least 98% by weight.

According to the specific use of the superabsorbent, another particle size distribution can be selected. In general, for use in shaping processes for thermoplastic mixtures which comprise the superabsorbent, the same particle size is selected as to date with noninventive superabsorbents. This is often smaller than usual in hygiene applications. For extrusion processes, for example, a screen cut of 5 to 50 μm or else of 50 to 150 μm is often selected.

In some other known production processes for superabsorbents, especially in suspension polymerization, spray polymerization or dropletization polymerization, the selection of the process parameters defines the particle size distribution. In these processes, particulate superabsorbents of the desired particle size are formed directly, such that grinding and screening steps can often be dispensed with; in some processes (especially in the case of spray or dropletization polymerization), a dedicated drying step can often also be dispensed with. The specific configuration of the production process for the inventive superabsorbent is unimportant for the present invention.

The polymer prepared as described so far has superabsorbent properties and is covered by the term “superabsorbent”. Its CRC is typically comparatively high, but its AUL or SFC are comparatively low. Such a surface nonpostcrosslinked superabsorbent is often distinguished from a surface postcrosslinked superabsorbent produced therefrom by calling it “base polymer”.

The superabsorbent particles are optionally surface postcrosslinked to further improve the properties, especially to increase the AUL and SFC values (in which case the CRC value falls). The postcrosslinking of superabsorbents is known per se.

Suitable postcrosslinkers are compounds which comprise groups which can form bonds with at least two functional groups of the superabsorbent particles. The superabsorbents based on acrylic acid/sodium acrylate which are prevalent on the market are suitable surface postcrosslinker compounds which comprise groups which can form bonds with at least two carboxylate groups. Preferred postcrosslinkers are:
di- or polyepoxides, for instance di- or polyglycidyl compounds, such as diglycidyl phosphonate, ethylene glycol diglycidyl ether or bischlorohydrin ether of polyalkylene glycols,
alkoxysilyl compounds,
polyaziridines, compounds comprising aziridine units and based on polyethers or substituted hydrocarbons, for example bis-N-aziridinomethane,
polyamines or polyamidoamines, and the reaction products thereof with epichlorohydrin,
polyols such as ethylene glycol, 1,2-propanediol, 1,4-butanediol, glycerol, methyltriglycol, polyethylene glycols with a mean molecular weight Mw of 200-10 000, di- and polyglycerol, pentaerythritol, sorbitol, the ethoxylates of these polyols and the esters thereof with carbonates, or of carbonic acid, such as ethylene carbonate or propylene carbonate,
carbonic acid derivatives such as urea, thiourea, guanidine, dicyandiamide, 2-oxazolidinone and derivatives thereof, bisoxazoline, polyoxazolines, di- and polyisocyanates,
di- and poly-N-methylol compounds, for example methylenebis(N-methylol-methacrylamide) or melamine-formaldehyde resins,
compounds with two or more blocked isocyanate groups, for example trimethyl-hexamethylene diisocyanate blocked with 2,2,3,6-tetramethylpiperidinone-4.

Optionally, it is possible to add acidic catalysts, for example p-toluenesulfonic acid, phosphoric acid, boric acid or ammonium dihydrogenphosphate.

Particularly suitable postcrosslinkers are di- or polyglycidyl compounds such as ethylene glycol diglycidyl ether, the reaction products of polyamidoamines with epichlorohydrin, 2-oxazolidinone and N-hydroxyethyl-2-oxazolidinone.

It is possible to use a single postcrosslinker from the above selection or any mixtures of different postcrosslinkers.

The postcrosslinker is generally used in an amount of at least 0.001% by weight, preferably of at least 0.02% by weight, more preferably of at least 0.05% by weight, and generally at most 2% by weight, preferably at most 1% by weight, more preferably at most 0.3% by weight, for example at most 0.15% by weight or at most 0.095% by weight, based in each case on the mass of the base polymer contacted therewith.

The postcrosslinking is typically carried out in such a way that a solution of the postcrosslinker is sprayed onto the dried base polymer particles. After the spray application, the polymer particles coated with postcrosslinker are dried thermally, and the postcrosslinking reaction may take place either before or during the drying. If surface postcrosslinkers with polymerizable groups are used, the surface postcrosslinking can also be effected by means of free-radically induced polymerization of such groups by means of common free-radical formers or else by means of high-energy radiation, for example UV light. This can be done in parallel or instead of the use of postcrosslinkers which form covalent or ionic bonds to functional groups at the surface of the base polymer particles.

The solvent used for the surface postcrosslinker is a customary suitable solvent, for example water, alcohols, DMF, DMSO and mixtures thereof. Particular preference is given to water and water/alcohol mixtures, for example water/methanol, water/1,2-propanediol and water/1,3-propanediol. The concentration of the postcrosslinker in the postcrosslinker solution is typically 1 to 20% by weight, preferably 1.5 to 10% by weight, more preferably 2 to 5% by weight, based on the postcrosslinker solution.

The spray application of the postcrosslinker solution is preferably carried out in mixers with moving mixing tools, such as screw mixers, disk mixers or paddle mixers, or mixers with other mixing tools. Particular preference is given, however, to vertical mixers. However, it is also possible to spray on the postcrosslinker solution in a fluidized bed. Suitable mixers are, for example, obtainable as Pflugschar® plowshare mixers from Gebr. Lödige Maschinenbau GmbH, Elsener-Strasse 7-9, 33102 Paderborn, Germany, or as Schugi® Flexomix® mixers, Vrieco-Nauta® mixers or Turbulizer® mixers from Hosokawa Micron BV, Gildenstraat 26, 7000 AB Doetinchem, the Netherlands.

In a known manner, a surfactant or deagglomeration assistant can be added to the postcrosslinker solution or actually to the base polymer. All anionic, cationic, nonionic and amphoteric surfactants are suitable as deagglomeration assistants, but preference is given to nonionic and amphoteric surfactants for skin compatibility reasons. The surfactant may also comprise nitrogen. For example, sorbitan monoesters, such as sorbitan monococoate and sorbitan monolaurate, or ethoxylated variants thereof, for example Polysorbat 20®, are added. Further suitable deagglomeration assistants are the ethoxylated and alkoxylated derivatives of 2-propylheptanol, which are sold under the Lutensol XL® and Lutensol XP® brands (BASF SE, Carl-Bosch-Strasse 38, 67056 Ludwigshafen, Germany). The deagglomeration assistant can be metered in separately or added to the postcrosslinker solution. Preference is given to simply adding the deagglomeration assistant to the postcrosslinker solution. The amount of the deagglomeration assistant used, based on base polymer, is, for example, from 0 to 0.1% by weight, preferably from 0 to 0.01% by weight, more preferably from 0 to 0.002% by weight. The deagglomeration assistant is preferably metered in such that the surface tension of an aqueous extract of the swollen base polymer and/or of the swollen postcrosslinked superabsorbent at 23° C. is at least 0.060 N/m, preferably at least 0.062 N/m, more preferably at least 0.065 N/m, and advantageously at most 0.072 N/m.

The actual surface postcrosslinking by reaction of the surface postcrosslinker with functional groups at the surface of the base polymer particles is usually carried out by heating the base polymer wetted with surface postcrosslinker solution, typically referred to as “drying” (but not to be confused with the above-described drying of the polymer gel from the polymerization, in which typically very much more liquid has to be removed). The drying can be effected in the mixer itself, by heating the jacket, by means of heat exchange surfaces or by blowing in warm gases. Simultaneous admixing of the superabsorbent with surface postcrosslinker and drying can be effected, for example, in a fluidized bed drier. The drying is, however, usually carried out in a downstream drier, for example a tray drier, a rotary tube oven, a paddle or disk drier or a heatable screw. Suitable driers are, for example, obtainable as Solidair® or Torusdisc® driers from Bepex International LLC, 333 N.E. Taft Street, Minneapolis, Minn. 55413, U.S.A., or as paddle driers or else as fluidized bed driers from Nara Machinery Co., Ltd., European Branch, Europaallee 46, 50226 Frechen, Germany.

Preferred drying temperatures are in the range from 100 to 250° C., preferably from 120 to 220° C., more preferably from 130 to 210° C., most preferably from 150 to 200° C. The preferred residence time at this temperature in the reaction mixer or drier is preferably at least 10 minutes, more preferably at least 20 minutes, most preferably at least 30 minutes, and typically at most 60 minutes. Typically, the drying is conducted such that the superabsorbent has a residual moisture content of generally at least 0.1% by weight, preferably at least 0.2% by weight and most preferably at least 0.5% by weight, and generally at most 15% by weight, preferably at most 10% by weight and more preferably at most 8% by weight.

In one embodiment of the invention, the hydrophilicity of the particle surface of the base polymers is modified by forming complexes. Complexes are formed on the outer shell of the particles by spray application of solutions of di- or polyvalent cations, the cations being able to react with the acid groups of the polymer to form complexes. Examples of di- or polyvalent cations are polymers formed, in a formal sense, entirely or partly from vinylamine monomers, such as partly or fully hydrolyzed polyvinylamide (so-called “polyvinylamine”), whose amine groups are always—even at very high pH values—present partly in protonated form to give ammonium groups, or metal cations such as Mg²⁺, Ca²⁺, Al³⁺, Sc³⁺, Ti⁴⁺, Mn²⁺, Fe^{2+/3+}, Co²⁺, Ni²⁺, Cu²⁺, Zn²⁺, Y³⁺, Zr⁴⁺, La³⁺, Ce⁴⁺, Hf⁴⁺, and Au³⁺. Preferred metal cations are Mg²⁺, Ca²⁺, Al³⁺, Ti⁴⁺, Zr⁴⁺ and La³⁺, and particularly preferred metal cations are Al³⁺, Ti⁴⁺ and Zr⁴⁺. The metal cations can be used either alone or in a mixture with one another. Among the metal cations mentioned, suitable metal salts are all of those which possess sufficient solubility in the solvent to be used. Particularly suitable metal salts are those with weakly complexing anions, for example chloride, nitrate and sulfate, hydrogensulfate, carbonate, hydrogencarbonate, nitrate, phosphate, hydrogenphosphate, dihydrogenphosphate and carboxylate, such as acetate and lactate. Particular preference is given to using aluminum sulfate. The solvents used for the metal salts may be water, alcohols, DMF, DMSO, and mixtures of these components. Particular preference is given to water and water/alcohol mixtures, for example water/methanol, water/1,2-propanediol and water/1,3-propanediol.

The base polymer is treated with a solution of a divalent or polyvalent cation in the same manner as that with surface postcrosslinker, including the optional drying step. Surface postcrosslinker and polyvalent cation can be sprayed on in a combined solution or as separate solutions. The spray application of the metal salt solution to the superabsorbent particles can be effected either before or after the surface postcrosslinking. In a particularly preferred process, the spray application of the metal salt solution is effected in the same step as the spray application of the crosslinker solution, both solutions being sprayed on separately and successively or simultaneously through two nozzles, or crosslinker and metal salt solutions may be sprayed on together through one nozzle.

If the surface postcrosslinking and/or treatment with complexing agent is followed by a drying step, it is advantageous but not absolutely necessary to cool the product after the drying step. The cooling can be effected continuously or batchwise; to this end, the product is conveniently conveyed continuously into a cooler connected downstream of the drier. To this end, it is possible to use any apparatus known for removal of heat from pulverulent solids, especially any apparatus mentioned above as a drying apparatus, provided that it is not charged with a heating medium but rather with a cooling medium, for instance with cooling water, such that no heat is introduced into the superabsorbent via the walls and, according to the construction, also via the stirrer units or other heat exchange surfaces, but rather removed therefrom. Preference is given to the use of coolers in which the product is moved, i.e. cooled mixers, for example paddle coolers or disk coolers. The superabsorbent can also be cooled in a fluidized bed by blowing in a cooled gas such as cold air. The cooling conditions are established such that a superabsorbent with the temperature desired for further processing is obtained. Typically, a mean residence time in the cooler of generally at least 1 minute, preferably at least 3 minutes and more preferably at least 5 minutes, and generally at most 6 hours, preferably at most 2 hours and more preferably at most 1 hour, is established, and the cooling performance is such that the resulting product has a temperature of generally at least 0° C., preferably at least 10° C. and more preferably at least 20° C., and generally at most 100° C., preferably at most 80° C. and more preferably at most 60° C.

The surface postcrosslinked superabsorbent or the mixture is optionally ground and/or screened in a customary manner. Grinding is typically not required here, but screening-off of agglomerates or fines formed is usually appropriate to establish the desired particle size distribution of the product. Agglomerates and fines are either discarded or preferably recycled into the process in a known manner at a suitable point; agglomerates after comminution. The particle sizes desired for surface postcrosslinked superabsorbents are the same as for base polymers.

It is optionally possible to additionally apply to the surface of the superabsorbent particles, in any process step of the preparation process, if required, all known additives or coatings, such as film-forming polymers, thermoplastic polymers, dendrimers, polycationic polymers (for example polyvinylamine, polyethyleneimine or polyallylamine), water-insoluble polyvalent metal salts, for example magnesium carbonate, magnesium oxide, magnesium hydroxide, calcium carbonate, calcium sulfate or calcium phosphate, all water-soluble mono- or polyvalent metal salts known to those skilled in the art, for example aluminum sulfate, sodium salts, potassium salts, zirconium salts or iron salts, or hydrophilic inorganic particles such as clay minerals, fumed silica, colloidal silica sols, for example Levasil®, titanium dioxide, aluminum oxide and magnesium oxide. Examples of useful alkali metal salts are sodium and potassium sulfate, and sodium and potassium lactates, citrates and sorbates. This allows additional effects, for example a reduced caking tendency of the end product or of the intermediate in the particular process step of the production process, improved processing properties or a further enhanced saline flow conductivity (SFC), to be achieved. When the additives are used and sprayed on in the form of dispersions, they are preferably used as aqueous dispersions, and preference is given to additionally applying an antidusting agent to fix the additive on the surface of the superabsorbent. The antidusting agent is then either added directly to the dispersion of the inorganic pulverulent additive; optionally, it can also be added as a separate solution before, during or after the application of the inorganic pulverulent additive by spray application. Most convenient is the simultaneous spray application of postcrosslinker, antidusting agent and pulverulent inorganic additive in the postcrosslinking step. In a further process variant, the antidusting agent is, however, added separately in the cooler, for example by spray application from above, below or from the side. Particularly suitable antidusting agents which can also serve to fix pulverulent inorganic additives on the surface of the superabsorbent particles are polyethylene glycols with a molecular weight of from 400 to 20 000 g/mol, polyglycerol, 3- to 100-tuply ethoxylated polyols such as trimethylolpropane, glycerol, sorbitol and neopentyl glycol. Particularly suitable are 7- to 20-tuply ethoxylated glycerol or trimethylolpropane, for example Polyol TP 70® (Perstorp, Sweden). The latter have, more particularly, the advantage that they lower the surface tension of an aqueous extract of the superabsorbent particles only insignificantly.

It is equally possible to adjust the inventive superabsorbent to a desired water content by adding water.

All coatings, solids, additives and assistants can each be added in separate process steps, but the most convenient method is usually to add them—if they are not added during the admixing of the base polymer with surface postcrosslinkers—to the superabsorbent in the cooler, for instance by spray application of a solution or addition in finely divided solid form or in liquid form.

The inventive superabsorbent generally has a centrifuge retention capacity (CRC) of at least 5 g/g, preferably of at least 10 g/g and more preferably of at least 20 g/g. Further suitable minimum values of the CRC are, for example, 25 g/g, 30 g/g or 35 g/g. It is typically not more than 40 g/g. A typical CRC range for surface postcrosslinked superabsorbents is from 28 to 33 g/g.

The inventive superabsorbent typically has an absorbency under load (AUL 0.7 psi, see below for test method) of at least 18 g/g, preferably at least 20 g/g, preferentially at least 22 g/g, more preferably at least 23 g/g, most preferably at least 24 g/g, and typically not more than 30 g/g.

The inventive superabsorbent additionally has a saline flow conductivity (SFC, see below for test method) of at least 10×10⁻⁷ cm³s/g, preferably at least 30×10⁻⁷ cm³s/g, preferentially at least 50×10⁻⁷ cm³s/g, more preferably at least 80×10⁻⁷ cm³s/g, most preferably at least 100×10⁻⁷ cm³s/g, and typically not more than 1000×10⁻⁷ cm³s/g.

The inventive superabsorbent can be used for any purpose for which known superabsorbents are also used. The inventive superabsorbent mixture can be used especially in fields of industry in which liquids, especially water or aqueous solutions, are absorbed. These fields are, for example, storage, packaging, transport (as constituents of packaging material for water- or moisture-sensitive articles, for instance for flower transport, and also as protection against mechanical effects); animal hygiene (in cat litter); food packaging (transport of fish, fresh meat; absorption of water, blood in fresh fish or meat packaging); medicine (wound plasters, water-absorbing material for burn dressings or for other weeping wounds), cosmetics (carrier material for pharmaceutical chemicals and medicaments, rheumatic plasters, ultrasonic gel, cooling gel, cosmetic thickeners, sunscreen); thickeners for oil/water or water/oil emulsions; textiles (moisture regulation in textiles, shoe insoles, for evaporative cooling, for instance in protective clothing, gloves, headbands); chemical engineering applications (as a catalyst for organic reactions, for immobilization of large functional molecules such as enzymes, as an adhesive in agglomerations, heat stores, filtration aids, hydrophilic components in polymer laminates, dispersants, liquefiers); as assistants in powder injection molding, in the building and construction industry (installation, in loam-based renders, as a vibration-inhibiting medium, assistants in tunnel excavations in water-rich ground, cable sheathing); water treatment, waste treatment, water removal (deicers, reusable sand bags); cleaning; agrochemical industry (irrigation, retention of melt water and dew deposits, composting additive, protection of forests from fungal/insect infestation, retarded release of active ingredients to plants); for firefighting or for fire protection; coextrusion agents in thermoplastic polymers (for example for hydrophilization of multilayer films); production of thermoplastic moldings (this includes films) which can absorb water (e.g. films which store rain and dew for agriculture; films comprising superabsorbents for maintaining freshness of fruit and vegetables which are packaged in moist films; superabsorbent-polystyrene coextrudants, for example for packaging foods such as meat, fish, poultry, fruit and vegetables); or as a carrier substance in active ingredient formulations (pharmaceuticals, crop protection).

A preferred use of the inventive superabsorbent is that as a constituent of thermoplastic mixtures, especially of those thermoplastic mixtures which are provided for shaping to shaped bodies. The inventive thermoplastic mixtures, methods for processing thereof and the shaped bodies produced therewith differ from known examples in that they comprise the inventive superabsorbent or in that the inventive superabsorbent is present.

Such thermoplastic mixtures which comprise superabsorbents are known per se. They typically comprise a proportion of a thermoplastic polymer, for example polyolefins such as polyethylene or polypropylene, polystyrene, polyesters such as polyethylene terephthalate or polybutylene terephthalate, polyvinyl chloride, polyamide, polycarbonate or polyurethane or copolymers, for example ethylene-vinyl acetate copolymer or acrylonitrile-butadiene-styrene copolymer, or a mixture of such polymers and/or copolymers. The thermoplastic content in the mixture must be at least sufficiently high that the material overall can be processed like a thermoplastic.

The thermoplastic mixture additionally comprises the inventive superabsorbent. The proportion thereof is at least sufficiently high that the desired water-absorbing properties are achieved.

In addition to a thermoplastic and the superabsorbent, the thermoplastic mixture may comprise further components which impart desired properties thereto and/or to the shaped body produced therefrom. Examples thereof are fillers, for instance inorganic fillers, for example inorganic oxides such as silicon oxides, aluminum oxides, titanium oxides or zirconium oxides, carbon blacks, elastomers, particulate elastomers, for example rubber particles, or any other additive known for such purposes.

The inventive mixture is produced and processed to shaped bodies in a customary manner. To this end, the thermoplastic mixture is generally obtained, made shapeable by heating and then shaped.

The thermoplastic mixture can be produced before shaping, but also during shaping. When the mixture is produced before shaping, for this purpose, the thermoplastic is typically melted and the other components are mixed in. The mixture can then be shaped directly, or cooled and shaped to semifinished products. Such semifinished products (for example pellets) can be transported to other sites for shaping to the end product. However, the mixture can also be obtained during the shaping, by, for example, supplying a thermoplastic to an extruder and feeding in the further components at different sites in the extruder. It is equally possible to mix portions of the desired end composition beforehand and to add the remaining components during the shaping. All of these are known measures of thermoplastics processing.

It may also be possible and desirable only to establish the final composition of the desired shaped body after the shaping. For example, the superabsorbent can be applied to the shaped product after the actual shaping—for instance the production of a thermoplastic film.

The thermoplastic mixture is shaped by any known method of shaping thermoplastics. Examples thereof are extrusion, injection, blow molding, thermoforming, calendering or compression molding. One process for which the inventive superabsorbent is particularly suitable is extrusion. Almost any shapes are producible by extrusion, including films.

The invention further provides shaped bodies formed from a thermoplastic mixture, wherein an inventive superabsorbent is a constituent of the mixture.

### Test Methods

The superabsorbent is tested by the test methods described below. The standard test methods referred to as “WSP” described below are described in: “Standard Test Methods for the Nonwovens Industry”, 2005 edition, published jointly by the Worldwide Strategic Partners EDANA (European Disposables and Nonwovens Association, Avenue Eugene Plasky, 157, 1030 Brussels, Belgium, www.edana.org) and INDA (Association of the Nonwoven Fabrics Industry, 1100 Crescent Green, Suite 115, Cary, N.C. 27518, U.S.A., www.inda.org). This publication is obtainable from EDANA or INDA.

All methods described below should, unless stated otherwise, be carried out at an ambient temperature of 23±2° C. and a relative air humidity of 50±10%. The superabsorbent particles are mixed thoroughly before the measurement unless stated otherwise.

### Centrifuge Retention Capacity (CRC)

The centrifuge retention capacity of the superabsorbent is determined by the standard test method No. WSP 241.5-02 “Centrifuge Retention Capacity”.

Absorbency under load of 0.7 psi (AUL 0.7 psi)

The absorbency under a load of 4826 Pa (0.7 psi) of the superabsorbent is determined analogously to the standard test method No. WSP 242.2-05 “Absorption under Pressure”, except using a weight of 49 g/cm² (leads to a load of 0.7 psi) instead of a weight of 21 g/cm² (leads to a load of 0.3 psi).

### Saline Flow Conductivity (SFC)

The saline flow conductivity of a swollen gel layer formed by the superabsorbent by liquid absorption under a pressure of 0.3 psi (2068 Pa) is, as described in EP 640 330 A1, determined as the gel layer permeability (“GLP”) of a swollen gel layer of superabsorbent particles (referred to in that document as “AGM” for “absorbent gelling material”), the apparatus described on page 19 and in FIG. 8 in the aforementioned patent application having been modified to the effect that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 640 330 A1. The flow is detected automatically.

The saline flow conductivity (SFC) is calculated as follows:

SFC[cm³s/g]=(Fg(t=0)×L0)/(d×A×WP),

where Fg(t=0) is the flow of NaCl solution in g/s, which is obtained using linear regression analysis of the Fg(t) data of the flow determinations by extrapolation to t=0, L0 is the thickness of the gel layer in cm, d is the density of the NaCl solution in g/cm³, A is the area of the gel layer in cm², and WP is the hydrostatic pressure over the gel layer in dyn/cm².

Moisture Content of the Superabsorbent (Residual Moisture, Water Content)

The water content of the superabsorbent particles is determined by the standard test method No. WSP 230.2-05 “Moisture Content”.

### Particle Size

The particle size of the product fraction is determined by the standard test method No. WSP 220.2-05 “Particle Size Distribution”.

1. A particulate superabsorbent based on at least one monoethylenically unsaturated monomer comprising at least one acid group, wherein at least 5 mol % of the acid groups are neutralized with at least one tertiary alkanolamine.

2. The superabsorbent according to claim 1, wherein at least 20 mol % of the acid groups are neutralized with at least one tertiary alkanolamine.

3. The superabsorbent according to claim 2, wherein at least 40 mol % of the acid groups are neutralized with at least one tertiary alkanolamine.

4. The superabsorbent according to claim 1, comprising essentially no other neutralizing agent than the tertiary alkanolamine.

5. The superabsorbent according to claim 1, wherein the tertiary alkanolamine is triethanolamine.

6. A process for producing a superabsorbent defined in claim 1 comprising polymerizing at least one monoethylenically unsaturated monomer comprising at least one acid group in the presence of a crosslinker, which comprises neutralizing at least 5 mol % of the acid groups with at least one tertiary alkanolamine before, during, or after the polymerization.

7. (canceled)

8. A process for shaping thermoplastic mixtures comprising shaping a thermoplastic mixture by heating, wherein the thermoplastic mixture comprises a superabsorbent of claim 1.

9. The process according to claim 8, further comprising an extrusion step.

10. A shaped body formed from a thermoplastic mixture, wherein the thermoplastic mixture comprises a superabsorbent of claim 1.

11. A thermoplastic mixture comprising a superabsorbent of claim 1.
